(19) United States
(12) Patent Application Publication
(10) Pub. No.: US 2025/0328178 A1
(43) Pub. Date: Oct. 23, 2025

(54) STARTUP METHOD AND PULLING STARTUP MODULE FOR ELECTRIC PULL DEVICE, AND PULL DEVICE

(71) Applicant: HangZhou YuShu TECHNOLOGY CO.,LTD., Hangzhou, Zhejiang (CN)

(72) Inventor: Xingxing Wang, Hangzhou, Zhejiang (CN)

(21) Appl. No.: 18/857,275

(22) PCT Filed: Dec. 14, 2022
(86) PCT No.: PCT/CN2022/139030

§ 371 Date: Jul. 1, 2025

(30) Foreign Application Priority Data
Apr. 18, 2022 (CN) 202210405027.3

(51) Int. Cl. G06F 1/26; G06F 9/4401; H02P 1/02

(52) U.S. Cl. CPC G06F 1/266; G06F 9/4403; H02P 1/02

(57) ABSTRACT

A startup method and a pulling startup module for an electric pull device, and a pull device, pertaining to the technical field of pull devices. According to the pulling startup method for an electric pull device, when the electric pull device is in a shutdown or dormant state, a user pulls a tension rope to drive a motor to rotate, thereby generating electric energy or an electric energy signal; and then startup control of the pull device is implemented by means of the electric energy or the electric energy signal. Accordingly, the pull device can be automatically started up by pulling the tension rope, so that the user may omit to press an on-off key for startup, making the operation simple and the pull device more interesting to attract customers, thereby effectively improving the user experience and facilitating popularization and use of the pull device.

### TECHNICAL FIELD

The present invention relates to a startup method and a pulling startup module for an electric pull device, and a pull device, pertaining to the technical field of pull devices.

### BACKGROUND

An electric pull device is a new type of fitness equipment, and a working principle thereof is that a motor outputs specified torque to drag a tension rope thereby providing resistance for exercise, so that muscles of the whole body may be trained through various actions. Compared to equipment such as dumbbells and elastic ropes, the electric pull device has advantages of stepless force adjustment and data visualization.

A Chinese patent (Publication No. CN214860870U) discloses a pull device driving unit with good heat dissipation effect and an electronic pull device provided with the same. The pull device driving unit includes a motor unit, a driving plate disposed at an axial lateral portion of the motor unit, and a heat conduction support member, where the motor unit includes a motor stator, and the heat conduction support member includes a heat conduction portion; the motor stator and the driving plate are respectively fixed on the heat conduction support member; and a wind source member is provided around the motor unit and configured to dissipate heat of the motor unit and the driving plate. In the pull device driving unit with good heat dissipation effect, the motor stator and the driving plate which generate a lot of heat during working are directly fixed on the heat conduction support member, so as to dissipate the heat generated by them through the heat conduction portion with a larger heat conduction area on the heat conduction support member, preventing local heat accumulation, and implementing active heat dissipation for the heat conduction portion and the motor unit through the wind source member with higher heat dissipation efficiency.

### BRIEF SUMMARY

### Technical Problems

However, the electric pull device disclosed by the above patent and the existing electric pull device need to be started up before use and can only be used after the device is energized, but cannot be used at any time desired, like conventional equipment such as dumbbells; and the use experience is often degraded due to an additional startup operation, affecting the popularization of the electric pull device.

### Solution of Problems

### Technical Solutions

In view of the defects of the prior art, the first purpose of the present invention is to provide an automatic startup module configured to detect pulling in an electric pull device, omitting an operation of pressing an on-off key for startup during use of the pull device, so that the pull device may be automatically started up by pulling a tension rope, thereby saving time and labor and implementing good user experience.

In view of the defects of the prior art, the first purpose of the present invention is to provide an automatic startup module configured to detect pulling in an electric pull device, omitting an operation of pressing an on-off key for startup during use of the pull device, so that the pull device may be automatically started up by pulling a tension rope, thereby saving time and labor and implementing good user experience.

The second purpose of the present invention is to provide a pulling startup module for an electric pull device, where the pulling startup module is provided with a driving unit, an energy storage unit, a switch control unit; the driving unit is configured to convert kinetic energy generated by a user pulling the pull device into electric energy and then transmit the electric energy to the energy storage unit for storage; when stored electric energy is sufficient to turn on a transistor, the transistor is turned on to implement startup control of the pull device, making the startup process simple and the pull device more interesting, thereby effectively improving the user experience and facilitating popularization and use of the pull device.

The third purpose of the present invention is to provide an electric pull device, where the electric pull device is provided with a tension rope, a motor, a driving unit, an energy storage unit, a switch control unit, and a processor; the driving unit is configured to convert kinetic energy generated by a user pulling the pull device into electric energy and then transmit the electric energy to the energy storage unit for storage; when stored electric energy is sufficient to turn on a transistor, the transistor is turned on to energize the motor or/and processor, implementing startup control of the pull device; the pull device may be automatically started up by pulling the tension rope, so that the user may omit to press an on-off key for startup, making the startup operation simple and the pull device more interesting to attract customers, thereby effectively improving the user experience and facilitating popularization and use of the pull device. As such, the processor does not need to be always in a working state, thereby effectively saving electric energy, prolonging use time of a battery of the pull device, and improving the service life of the electric pull device.

The fourth purpose of the present invention is to provide a startup method for an electric pull device, where the pull device can be automatically started up by pulling a tension rope, so that a user may omit to press an on-off key for startup, making the startup operation simple and the pull device more interesting to attract customers, thereby effectively improving the user experience and facilitating popularization and use of the pull device.

In order to achieve one of the above purposes, the first technical solution of the present invention is as follows:
a pulling startup method for an electric pull device, where when the electric pull device is in a shutdown or dormant state, a user pulls a tension rope to drive a motor to rotate, thereby generating electric energy or an electric energy signal; and then startup control of the pull device is implemented by means of the electric energy or the electric energy signal.

According to the present invention, the pull device can be automatically started up by pulling the tension rope, so that the user may omit to press an on-off key for startup, making the operation simple and the pull device more interesting to attract customers, thereby effectively improving the user experience and facilitating popularization and use of the pull device. The solution is simple and practical and may facilitate manufacturing.

As a preferable technical measure:
a process of implementing the startup control of the pull device by means of an electric energy signal is as follows: when the pull device is in the shutdown or dormant state, the user pulls the tension rope to drive the motor to rotate, thereby generating the electric energy signal; and a processor completes a startup process when detecting the electric energy signal. The solution is simple, practical, and feasible.

As a preferable technical measure:
the processor detects the electric energy signal by means of a method as follows: during a shutdown, the processor is not deenergized and is in a state of monitoring a change in electric energy in real time.

The state is implemented by detecting a voltage signal manifested by the electrical energy through real-time analog-to-digital conversion, or by detecting a rising edge trigger; and when the processor detects the electric energy signal, the processor works to control a power switch to be turned on, so as to implement the startup of the pull device. The solution is detailed and easy to be implemented.

As a preferable technical measure:
a process of implementing the startup control of the pull device by means of electric energy is as follows: when the pull device is in the shutdown or dormant state, the user pulls the tension rope to drive the motor to rotate; and the rotating motor generates electric energy which energizes a processor or a switch control unit to implement the startup of the pull device. The solution is simple, practical, and feasible.

As a preferable technical measure:
a process of implementing the startup control of the pull device by means of electric energy is as follows: when the pull device is in the shutdown or dormant state, the user pulls the tension rope to drive the motor to rotate; and the rotating motor generates electric energy which, after being converted and accumulated, forms electric energy sufficient to turn on a transistor, and then the transistor is turned on to energize a processor or a switch control unit to implement the startup of the pull device. The solution is simple, practical, and facilitates production and manufacturing.

In order to achieve one of the above purposes, the second technical solution of the present invention is as follows:
a pulling startup module for an electric pull device, which adopts the pulling startup method for an electric pull device described above and includes a processor and a signal detection sensor, where the processor is configured to control startup of a motor; the signal detection sensor is configured to detect an electric energy signal generated by pulling the motor; and after the electric energy signal generated by pulling the motor is detected by the signal detection sensor, the signal detection sensor sends a startup signal to the processor, and then the processor controls startup of the pull device.

According to the present invention, the electric energy signal is generated by pulling the motor and captured by the signal detection sensor, to implement automatic startup of the pull device, so that the user may omit to press an on-off key for startup, making the operation simple and the pull device more interesting to attract customers, thereby effectively improving the user experience and facilitating popularization and use of the pull device.

Further, the signal detection sensor is a voltage transformer, a Hall voltage sensor, a fiber optic voltage sensor, or other sensors that may implement electric energy detection.

In order to achieve one of the above purposes, the third technical solution of the present invention is as follows:
a pulling startup module for an electric pull device, which adopts the pulling startup method for an electric pull device described above and includes a processor and/or a switch control unit, where the processor and/or the switch control unit is provided with at least one transistor and configured to control startup of a motor; electric energy is generated by pulling the motor, and when electric energy is sufficient to turn on a transistor, the transistor is turned on to implement startup control of the pull device.

According to the present invention, the electric energy is generated by pulling the motor to turn on the transistor, implementing automatic startup of the pull device, so that the user may omit to press an on-off key for startup, making the operation simple and the pull device more interesting to attract customers, thereby effectively improving the user experience and facilitating popularization and use of the pull device. As such, the processor does not need to be always in a working state, thereby effectively saving electric energy, prolonging use time of a battery of the pull device, and improving the service life of the electric pull device.

As a preferable technical measure:
the switch control unit includes a switch triode and a switch MOS transistor; the switch triode includes a switch collector c, a switch base b, and a switch emitter e; the switch MOS transistor includes a switch source S, a switch gate G, and a switch drain D; a branch circuit of the switch collector c is electrically connected to the switch gate G, and another branch circuit is electrically connected to a power bus via a branch circuit resistor; the switch base b is provided with an electric energy introduction interface configured to receive electric energy; the switch emitter e is grounded; the switch source S is electrically connected to the power bus; and the switch drain D is connected to a motor bus or a motor switch control circuit. According to the present invention, with full consideration on turning-on characteristics of the triode and the MOS transistor, the triode is used in conjunction with the MOS transistor, so that on the one hand, the switch triode may be turned on using less electric energy, and on the other hand, a voltage the power bus may be kept stable, thereby implementing startup control of the pull device. The solution is simple, practical, and skillfully designed.

In order to achieve one of the above purposes, the fourth technical solution of the present invention is as follows:
a pulling startup module for an electric pull device, which adopts the pulling startup method for an electric pull device described above and includes a driving unit, an energy storage unit, and a switch control unit, where the driving unit is provided with a bridge circuit and configured to rectify and convert alternating current electric energy generated by a user pulling a motor into direct current electric energy; the energy storage unit is provided with a capacitor and configured to store electric energy output by the driving unit;
the switch control unit is provided with at least one transistor and configured to control startup of the motor; the driving unit transmits, by means of a circuit, the direct current electrical energy to the energy storage unit for storage; and when stored electric energy is sufficient to turn on a transistor, the transistor is turned on to implement startup control of the pull device.

According to the present invention, after continuous exploration and experimentation, the driving unit, the energy storage unit, the switch control unit are provided, where the driving unit is configured to convert kinetic energy generated by the user pulling the pull device into electric energy and then transmit the electric energy to the energy storage unit for storage; when stored electric energy is sufficient to turn on the transistor, the transistor is turned on to implement startup control of the pull device.

Further, the electric pull device according to the present invention can be automatically started up when the user pulls the tension rope, so that the user may omit to press an on-off key for startup, simplifying the startup steps and making the startup process full of fun, thereby effectively improving the user experience and facilitating popularization and use of the pull device.

Furthermore, the processor of the electric pull device according to the present invention may timely be shut down or become dormant, so that the processor does not need to be always in a working state, thereby effectively saving electric energy, prolonging use time of a battery of the pull device, and improving the service life of the electric pull device.

The transistor is a triode, a field effect transistor, or a diode.

The triode is preferable, because on the one hand, it can better satisfy a requirement of a scenario of the present application, and on the other hand, it has a low manufacturing cost so that a manufacturing cost of the present invention may be reduced.

As a preferable technical measure:
the pulling startup module further includes a power bus, a system bus, a motor bus, a main switch control line, a motor switch control line, and an energy release unit.

The bridge circuit includes a plurality of field effect transistors forming a full-bridge rectification structure; there are a plurality of capacitors; the plurality of capacitors are connected in parallel to form an energy storage structure; the energy storage structure is capable of storing electric energy for turning on the transistor or/and storing electric energy for rotating the motor. According to the present invention, the kinetic energy generated by the user pulling the pull device may be converted into electric energy for storage, and when a capacity of the capacitors is sufficient to drive the motor to rotate, there is no need to provide a battery, thereby effectively reducing the weight of the pull device and the volume of the pull device, making the pull device of the present invention compact in structure and small in size.

Alternatively, a battery is provided and used only in a special situation, while the battery does not need to supply power in a normal situation, thereby effectively reducing the number of times of using the battery, and prolonging the service life of the pull device. The transistor is a triode I including a first collector c, a first base b, and a first emitter e.

As a preferable technical measure:
the power bus is configured to be connected to a power supply or a battery and supply power to the motor; the system bus is configured to be connected to the power bus and the motor bus; the motor bus is configured to be connected to the motor and a control unit; and the power bus, the system bus, and the motor bus form a main circuit. The main switch control line is configured to be connected to a system main switch and a control unit; and the motor switch control line is configured to be connected to a motor switch and a control unit. The main switch control line and the motor switch control line form a control circuit.

The energy release unit is provided with a power resistor and an NMOS transistor and configured to release the electric energy of the energy storage unit to implement shutdown control of the motor, avoiding constant energization of the system that can only be shut down after all the electric energy in the energy storage unit has been released slowly.

The control circuit and the main circuit are configured independently and connected effectively, to avoid impacts of components, such as a triode, on the main circuit and make the circuit control more accurate and effective.

As a preferable technical measure:

The power bus is electrically connected to the first collector c via a PMOS transistor I; the motor bus and the main switch control line are electrically connected to the first base b separately, so that a main switch and the motor separately control turning-on of the triode; and the first emitter e is grounded.

The PMOS transistor I is added to control on and off of the main circuit, which, compared with direct control implemented through the triode, can effectively avoid a voltage drop of the main circuit, thereby improving the stability of the main circuit.

As a preferable technical measure:
the PMOS transistor I is provided with a first source S, a first gate G and a first drain D; the first source S of the PMOS transistor I is connected to the power bus, the first gate G is connected to the first collector c, and the first drain D is electrically connected to the motor bus; when a voltage at the first collector c is zero, a voltage at the first gate G is zero, and the PMOS transistor I is turned on to implement energization control of the motor bus.

According to the present invention, with full consideration on turning-on characteristics of the triode and the PMOS transistor, the triode is used in conjunction with the PMOS transistor, so that on the one hand, the voltage of the main circuit may be kept stable, and on the other hand, less stored electric energy may be used for power supply to energize the control circuit and the main circuit, thereby implementing startup control of the pull device. The solution is simple, practical, and skillfully designed.

As a preferable technical measure:

The first drain D is electrically connected to the motor bus via a PMOS transistor II; the PMOS transistor II is provided with a second source S, a second gate G, and a second drain D; the second source S is electrically connected to the first drain D; the second gate G is electrically connected to the motor switch control line via a triode II; the second drain D is electrically connected to the motor bus; the triode II includes a second collector c, a second base b, and a second emitter e; the second collector c is electrically connected to the second gate G; the second base b is electrically connected to the motor switch control line; the second emitter e is grounded; the motor switch control line is energized to control turning-on of the triode II, causing a voltage of the second gate G to be zero; the PMOS transistor II is turned on, and then the motor bus is energized to control startup of the motor.

The PMOS transistor II is added to make the startup control of the motor more accurate, thereby avoiding the occurrence of error startup.

In order to achieve one of the above purposes, the fifth technical solution of the present invention is as follows:
an electric pull device capable of pulling startup, which adopts the pulling startup module for an electric pull device described above or adopts the pulling startup method for an electric pull device described above, and includes a tension rope, a motor, a driving unit, an energy storage unit, a switch control unit, and a processor, where the tension rope may be used to pull the motor, causing rotation of the motor to generate a counter electromotive force; the driving unit is provided with a bridge circuit and configured to rectify and convert alternating current electric energy into direct current electric energy; the energy storage unit is provided with at least one capacitor and configured to store electric energy transmitted by the driving unit; the switch control unit is provided with at least one transistor and configured to control energization of the motor or/and the processor; the processor is configured to control the rotation of the motor; when a user pulls the motor through the tension rope, the motor generates the counter electromotive force and transmits the same to the driving unit through a circuit; the driving unit converts the counter electromotive force into direct current electric energy and transmits the direct current electric energy to the energy storage unit for storage; when stored electric energy is sufficient to turn on the transistor, the transistor is turned on, and then the motor or/and the processor is energized to start to work, thereby implementing startup control of the pull device.

According to the present invention, after continuous exploration and experimentation, the tension rope, the motor, the driving unit, the energy storage unit, the switch control unit, and the processor are provided, where the driving unit is configured to convert kinetic energy generated by the user pulling the pull device into electric energy and then transmit the electric energy to the energy storage unit for storage; when stored electric energy is sufficient to turn on the transistor, the transistor is turned on to energize the motor or/and the processor, thereby implementing startup control of the pull device.

Meanwhile, according to the present invention, the pull device can be automatically started up by pulling the tension rope, so that the user may omit to press an on-off key for startup, making the operation simple and the pull device more interesting to attract customers, thereby effectively improving the user experience and facilitating popularization and use of the pull device. As such, the processor does not need to be always in a working state, thereby effectively saving electric energy, prolonging use time of a battery of the pull device, and improving the service life of the electric pull device.

Further, the motor is a permanent magnet synchronous motor or a brush motor.

As a preferable technical measure:
the electric pull device further includes a motor main switch, a power bus, a system bus, a motor bus, a main switch control line, and a motor switch control line.

The motor main switch is a button switch, a touch switch, or a toggle switch and configured to control on and off of the processor and the motor.

The power bus is configured to be connected to a power supply or a battery and supply power to the motor. The system bus is configured to be connected to the power bus and the motor bus. The motor bus is configured to be connected to the motor and a control unit. The main switch control line is configured to be connected to a system main switch and a control unit. The motor switch control line is configured to be connected to a motor switch and a control unit. The transistor is a triode I including a first collector c, a first base b, and a first emitter e. A branch circuit of the power bus is electrically connected to the first collector c via a PMOS transistor I and another branch circuit is electrically connected to the first collector c via a resistor I. The motor bus and the main switch control line are electrically connected to the first base b separately, so that a main switch and the motor separately control turning-on of the triode. The first emitter e is grounded. The PMOS transistor I is provided with a first source S, a first gate G and a first drain D. The first source S of the PMOS transistor I is connected to the power bus, the first gate G is connected to the first collector c, and the first drain D is electrically connected to the motor bus via the system bus. When a voltage at the first collector c is zero, a voltage at the first gate G is zero, and the PMOS transistor I is turned on to implement energization control of the motor bus. The system bus is electrically connected to the motor bus via a PMOS transistor II. The PMOS transistor II is provided with a second source S, a second gate G, and a second drain D. The second source S is electrically connected to the first drain D via the system bus. The second gate G is electrically connected to the motor switch control line via a triode II. The second drain D is electrically connected to the motor bus. The triode II includes a second collector c, a second base b, and a second emitter e. A branch circuit of the second collector c is electrically connected to the second gate G, and another branch circuit is connected to the system bus via a resistor II. The second base b is electrically connected to the motor switch control line. The second emitter e is grounded. The motor switch control line is energized to control turning-on of the triode II, causing a voltage of the second gate G to be zero. The PMOS transistor II is turned on, and then the motor bus is energized to control startup of the motor.

According to the present invention, with full consideration on turning-on characteristics of the triode and the PMOS transistor, a plurality of triodes are used in conjunction with the PMOS transistor, so that on the one hand, the voltage of the main circuit may be kept stable, and on the other hand, less stored electric energy may be used for power supply to energize the control circuit and the main circuit, thereby implementing startup control of the pull device. The solution is simple, practical, and skillfully designed.

In order to achieve one of the above purposes, the sixth technical solution of the present invention is as follows:
a pulling startup method for an electric pull device, where when the pull device is in a shutdown or dormant state, a user pulls a tension rope to drive a motor to rotate; and the rotating motor generates an electromotive force which, after being converted and accumulated, forms electric energy sufficient to turn on a transistor, and then the transistor is turned on to energize a motor switch circuit, thereby implementing startup control of the pull device.

According to the present invention, the pull device can be automatically started up by pulling the tension rope, so that the user may omit to press an on-off key for startup, making the operation simple and the pull device more interesting to attract customers, thereby effectively improving the user experience and facilitating popularization and use of the pull device. As such, the processor does not need to be always in a working state, thereby effectively saving electric energy, prolonging use time of a battery of the pull device, and improving the service life of the electric pull device.

In order to achieve one of the above purposes, the seventh technical solution of the present invention is as follows:
a pulling startup method for an electric pull device, including the following steps:
in a first step, when the pull device is in the shutdown or dormant state, the user pulls the tension rope to drive the direct current brushless motor to rotate, and then the rotation of the direct current brushless motor generates an alternating current counter electromotive force, which is rectified and converted into direct current electric energy by a bridge circuit in the driving unit;
in a second step, the direct current electric energy obtained in the first step is transmitted to an energy storage unit to implement electric energy storage; in a third step, when the electric energy obtained in the second step reaches a voltage required to turn on a transistor, the transistor is turned on, a system main switch is turned on, a system bus is energized, and then a processor is energized and starts to work; in a fourth step, after the processor in the third step starts to work, a main switch control line is first turned on to keep the system main switch on, then a voltage of the energy storage unit or a motor bus is detected, and when the voltage reaches a preset threshold, pulling startup is determined; in a fifth step, when the pulling startup is determined in the fourth step, a motor control line is turned on to turn on a motor control switch, the driving unit is energized and starts to work normally, thereby completing a whole startup process.

When the pull device needs to be shut down, the motor control switch is turned off first, then an energy release control line is turned on to completely release electric energy in the energy storage unit, and afterward, the main switch is turned off to complete a shutdown process, avoiding constant energization of the system that can only be shut down after all the electric energy in the energy storage unit has been released slowly.

According to the present invention, he driving unit is configured to convert kinetic energy generated by the user pulling the pull device into electric energy and then transmit the electric energy to the energy storage unit for storage; when stored electric energy is sufficient to turn on the transistor, the transistor is turned on to energize the motor or/and the processor, thereby implementing startup control of the pull device. The solution is detailed, practical, and feasible.

### Beneficial Effects of the Invention

### Beneficial Effects

According to the present invention, the pull device can be automatically started up by pulling the tension rope, so that the user may omit to press an on-off key for startup, making the operation simple and the pull device more interesting to attract customers, thereby effectively improving the user experience and facilitating popularization and use of the pull device.

Further, according to the present invention, after continuous exploration and experimentation, the driving unit, the energy storage unit, the switch control unit are provided, where the driving unit is configured to convert kinetic energy generated by the user pulling the pull device into electric energy and then transmit the electric energy to the energy storage unit for storage; when stored electric energy is sufficient to turn on the transistor, the transistor is turned on to implement startup control of the pull device.

Furthermore, according to the present invention, the pull device can be automatically started up by pulling the tension rope, so that the user may omit to press an on-off key for startup, making the operation simple, thereby effectively improving the user experience and facilitating popularization and use of the pull device. As such, the processor does not need to be always in a working state, thereby effectively saving electric energy, prolonging use time of a battery of the pull device, and improving the service life of the electric pull device.

### BRIEF DESCRIPTION OF THE DRAWINGS

### Description of the Drawings

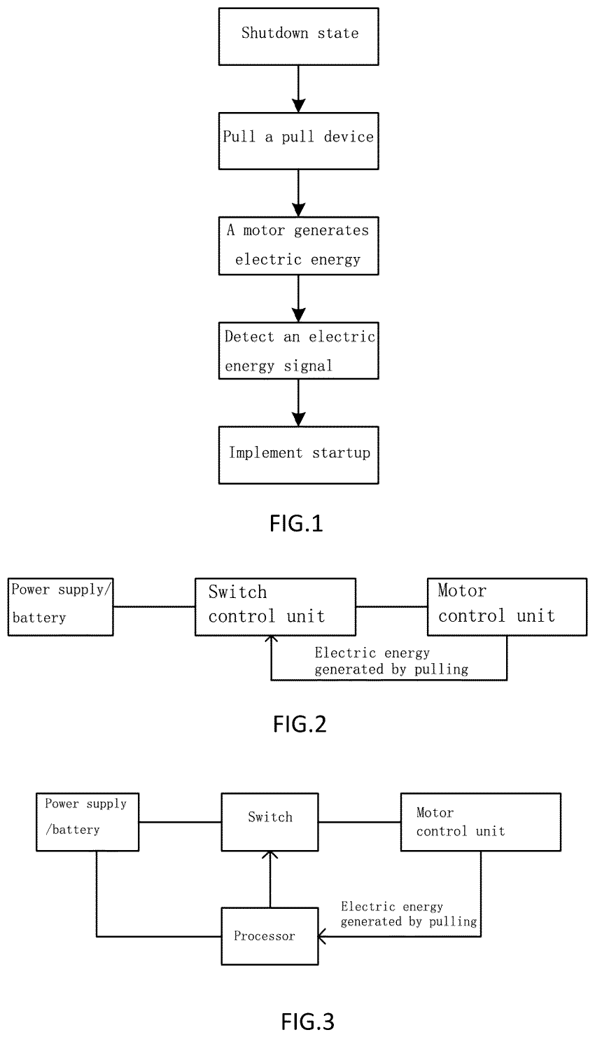

FIG. 1 is a flowchart of implementing startup by means of an electric energy signal according to the present invention;

FIG. 2 is a first schematic structural diagram of implementing startup by means of electric energy according to the present invention;

FIG. 3 is a second schematic structural diagram of implementing startup by means of electric energy according to the present invention;

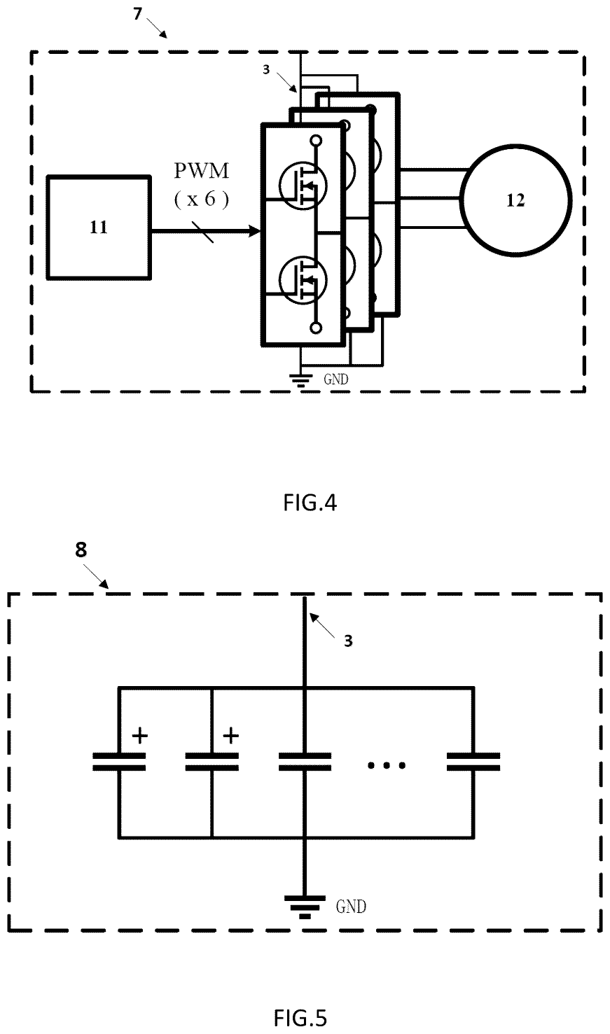

FIG. 4 is a schematic structural diagram of a driving unit equipped with a motor and a processor according to the present invention;

FIG. 5 is a schematic structural diagram of an energy storage unit according to the present invention;

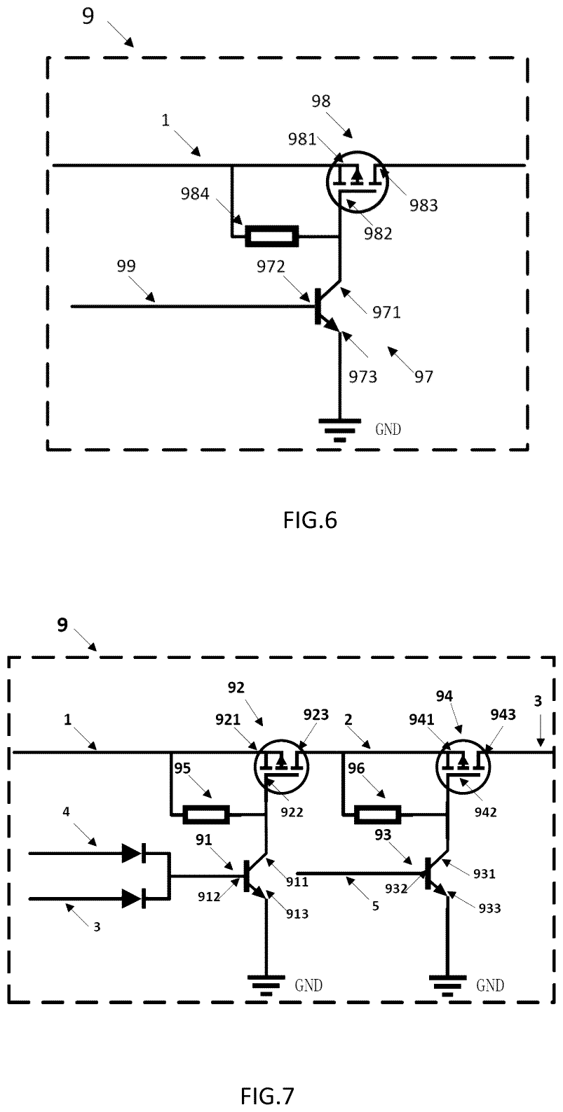

FIG. 6 is a first schematic structural diagram of a switch control unit according to the present invention;

FIG. 7 is a second schematic structural diagram of a switch control unit according to the present invention;

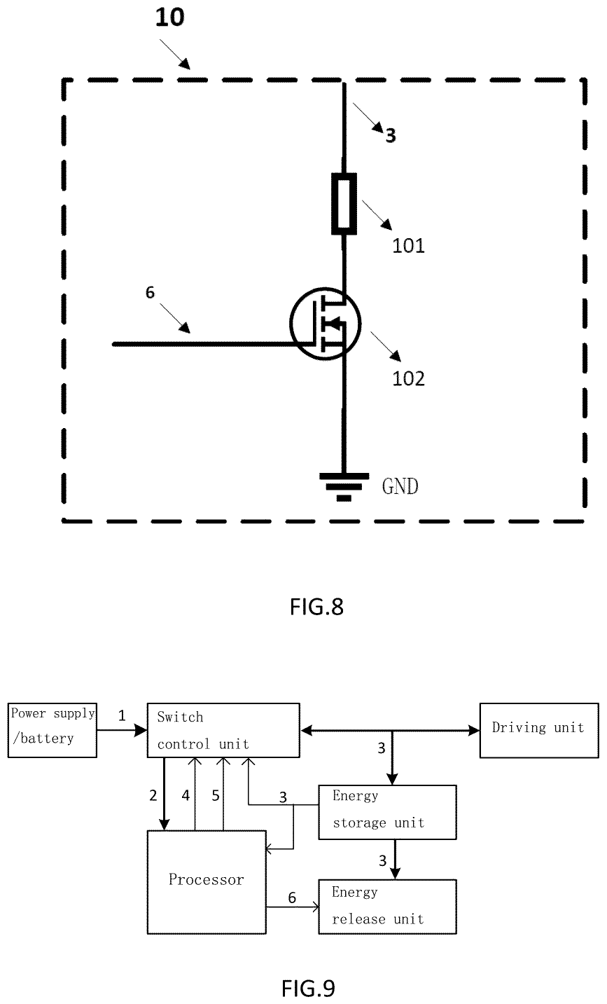

FIG. 8 shows a structure of an energy release unit according to the present invention; and

FIG. 9 is a schematic structural diagram of a pulling startup module according to the present invention.

### DESCRIPTION OF REFERENCE NUMERALS

1, power bus; 2, system bus; 3, motor bus; 4, main switch control line; 5, motor switch control line;
6, energy release control line; 7, driving unit; 8, energy storage unit; 9, switch control unit; 10, energy release unit; 11, processor; 12, motor; 91, triode I; 92, PMOS transistor I; 93, triode II; 94, PMOS transistor II; 95, resistor I; 96, resistor II; 97, switch triode; 98, switch MOS transistor; 99, electric energy introduction interface; 911, first collector c; 912, first base b; 913, first emitter e; 921, first source S; 922, first gate G; 923, first drain D; 931, second collector c; 932, second base b; 933, second emitter e; 941, second source S; 942, second gate G; 943, second drain D; 971, switch collector c; 972, switch base b; 973, switch emitter e; 981, switch source S; 982, switch gate G; 983, switch drain D; 984, branch resistor; 101, power resistor; 102, NMOS transistor.

### EMBODIMENTS OF THE INVENTION

### Implementations of the Invention

In order to make the purpose, technical solutions, and advantages of the present invention clearer, the present invention will be further described below in conjunction with the accompanying drawings and embodiments. It should be understood that the specific embodiments described herein are only used to explain the present invention, but are not intended to limit the present invention.

On the contrary, the present invention covers any alternatives, modifications, equivalent methods and solutions defined by the claims within the spirit and scope of the present invention. Further, in order to enable the public to have a better understanding of the present invention, some specific details are described in detail in the following detailed description of the present invention. Those skilled in the art can fully understand the present invention without the description of these details.

Unless otherwise defined, all technical and scientific terms used herein have the same meanings as those commonly understood by those skilled in the art to which the present invention belongs. The terms used herein are merely for the purpose of describing specific embodiments, but are not intended to limit the present invention. The term “and/or” as used herein includes any and all combinations of one or more related listed items.

A first specific embodiment of a pulling startup method according to the present invention is as follows:
a pulling startup method for an electric pull device, where
when the electric pull device is in a shutdown or dormant state, a user pulls a tension rope to drive a motor 12 to rotate, thereby generating electric energy or an electric energy signal; and then startup control of the pull device is implemented by means of the electric energy or the electric energy signal.

As shown in FIG. 1, in a specific embodiment of the present invention, the startup of the pull device is implemented by means of an electric energy signal.

A process of implementing the startup control of the pull device by means of an electric energy signal is as follows:
when the pull device is in the shutdown or dormant state, the user pulls the tension rope to drive the motor 12 to rotate, thereby generating the electric energy signal; and
a processor 11 completes a startup process when detecting the electric energy signal. The solution is simple, practical, and feasible.

The processor 11 detects the electric energy signal by means of a method as follows:
during a shutdown, the processor 11 is not deenergized and is in a state of monitoring a change in electric energy in real time; the state is implemented by detecting a voltage signal manifested by the electrical energy through real-time analog-to-digital conversion, or by detecting a rising edge trigger; and when the processor 11 detects the electric energy signal, the processor 11 works to control a power switch to be turned on, so as to implement the startup of the pull device. The solution is detailed and easy to be implemented.

As shown in FIGS. 2-3, in a specific embodiment of the present invention, the startup of the pull device is implemented by means of electric energy.

A process of implementing the startup control of the pull device by means of electric energy signal is as follows:
when the pull device is in the shutdown or dormant state, the user pulls the tension rope to drive the motor 12 to rotate; and the rotating motor 12 generates electric energy which energizes a processor 11 or a switch control unit 9 to implement the startup of the pull device. The solution is simple, practical, and feasible.

In a specific embodiment of the present invention, a transistor is added to implement the startup of the pull device.

A process of implementing the startup control of the pull device by means of electric energy signal is as follows:
when the pull device is in the shutdown or dormant state, the user pulls the tension rope to drive the motor 12 to rotate; and the rotating motor 12 generates electric energy which, after being converted and accumulated, forms electric energy sufficient to turn on a transistor, and then the transistor is turned on to energize a processor 11 or a switch control unit 9 to implement the startup of the pull device. The solution is simple, practical, and facilitates production and manufacturing.

A first specific embodiment of a pulling startup module according to the present invention is as follows:
a pulling startup module for an electric pull device, which adopts the pulling startup method for an electric pull device described above and includes a processor 11 and a signal detection sensor, where the processor 11 is configured to control startup of a motor 12; the signal detection sensor is configured to detect an electric energy signal generated by pulling the motor 12; and after the electric energy signal generated by pulling the motor 12 is detected by the signal detection sensor, the signal detection sensor sends a startup signal to the processor 11, and then the processor 11 controls startup of the pull device.

A second specific embodiment of a pulling startup module according to the present invention is as follows:
a pulling startup module for an electric pull device, which adopts the pulling startup method for an electric pull device described above and includes a processor 11 and/or a switch control unit 9, where the processor 11 and/or the switch control unit 9 is provided with at least one transistor and configured to control startup of a motor 12; electric energy is generated by pulling the motor 12, and when electric energy is sufficient to turn on a transistor, the transistor is turned on to implement startup control of the pull device. As shown in FIGS. 4-7, a third specific embodiment of a pulling startup module according to the present invention is as follows:
a pulling startup module for an electric pull device, which includes a driving unit 7, an energy storage unit 8, and a switch control unit 9, where the driving unit 7 is provided with a bridge circuit and configured to rectify and convert electromotive force generated by a user pulling a motor 12 into direct current electric energy; and the bridge circuit includes a plurality of field effect transistors forming a full-bridge rectification structure.

The energy storage unit 8 is provided with a capacitor and configured to store electric energy output by the driving unit 7. There are a plurality of capacitors.

The plurality of capacitors are connected in parallel to form an energy storage structure. The energy storage structure is capable of storing electric energy for turning on the transistor or/and storing electric energy for rotating the motor 12. The switch control unit 9 is provided with at least one transistor and configured to control startup of the motor 12; the driving unit 7 transmits, by means of a circuit, the direct current electrical energy to the energy storage unit 8 for storage; and when stored electric energy is sufficient to turn on a transistor, the transistor is turned on to implement startup control of the pull device.

A specific embodiment of a structure of the transistor according to the present invention is as follows:
the transistor is a triode I 91 including a first collector c 911, a first base b 912, and a first emitter e 913.

A fourth specific embodiment of a pulling startup module according to the present invention is as follows:
a pulling startup module for an electric pull device, which includes a driving unit 7, an energy storage unit 8, a switch control unit 9, a power bus 1, a system bus 2, a motor bus 3, a main switch control line 4, and a motor switch control line 5.

The driving unit 7 is provided with a bridge circuit and configured to rectify and convert electromotive force generated by a user pulling a motor 12 into direct current electric energy. The energy storage unit 8 is provided with a capacitor and configured to store electric energy output by the driving unit 7.

The switch control unit 9 is provided with at least one transistor and configured to control startup of the motor 12. The power bus 1 is configured to be connected to a power supply or a battery and supply power to the motor 12. The system bus 2 is configured to be connected to the power bus 1 and the motor bus 3. The motor bus 3 is configured to be connected to the motor 12 and a control unit. The power bus 1, the system bus 2, and the motor bus 3 form a main circuit. The main switch control line 4 is configured to be connected to a system main switch and a control unit; and the motor switch control line 5 is configured to be connected to a motor switch and a control unit. The main switch control line 4 and the motor switch control line 5 form a control circuit.

The driving unit 7 transmits, by means of a circuit, the direct current electrical energy to the energy storage unit 8 for storage; and when stored electric energy is sufficient to turn on a transistor, the transistor is turned on to implement startup control of the system main switch or/and the processor or/and the motor in the pull device.

The control circuit and the main circuit are configured independently and connected effectively, to avoid impacts of components, such as a triode, on the main circuit and make the circuit control more accurate and effective.

A specific embodiment of adding a PMOS transistor according to the present invention is as follows: the power bus 1 is electrically connected to the first collector c 911 via a PMOS transistor I 92; the motor bus 3 and the main switch control line 4 are electrically connected to the first base b 912 separately, so that a main switch and the motor 12 separately control turning-on of the triode; and the first emitter e 913 is grounded.

The PMOS transistor I 92 is added to control on and off of the main circuit, which, compared with direct control implemented through the triode, can effectively avoid a voltage drop of the main circuit, thereby improving the stability of the main circuit. The PMOS transistor I 92 is provided with a first source S 921, a first gate G 922 and a first drain D 923. The first source S 921 of the PMOS transistor I 92 is connected to the power bus 1, the first gate G 922 is connected to the first collector c 911, and the first drain D 923 is electrically connected to the motor bus 3. When a voltage at the first collector c 911 is zero, a voltage at the first gate G 922 is zero, and the PMOS transistor I 92 is turned on to implement energization control of the motor bus 3.

According to the present invention, with full consideration on turning-on characteristics of the triode and the PMOS transistor, the triode is used in conjunction with the PMOS transistor, so that on the one hand, the voltage of the main circuit may be kept stable, and on the other hand, less stored electric energy may be used for power supply to energize the control circuit and the main circuit, thereby implementing startup control of the pull device. The solution is simple, practical, and skillfully designed.

A specific embodiment of providing two PMOS transistors and a triode according to the present invention is as follows:
the first drain D 923 is electrically connected to the motor bus 3 via a PMOS transistor II 94; the PMOS transistor II 94 is provided with a second source S 941, a second gate G 942, and a second drain D 943; the second source S 941 is electrically connected to the first drain D 923; the second gate G 942 is electrically connected to the motor switch control line 5 via a triode II 93; the second drain D 943 is electrically connected to the motor bus 3; the triode II 93 includes a second collector c 931, a second base b 932, and a second emitter e 933; the second collector c 931 is electrically connected to the second gate G 942; the second base b 932 is electrically connected to the motor switch control line 5; the second emitter e 933 is grounded; the motor switch control line 5 is energized to control turning-on of the triode II 93, causing a voltage of the second gate G 942 to be zero; the PMOS transistor II 94 is turned on, and then the motor bus 3 is energized to control startup of the motor 12.

The PMOS transistor II 94 is added to make the startup control of the motor 12 more accurate, thereby avoiding the occurrence of error startup.

As shown in FIG. 8, in a specific embodiment of the present invention, an energy release unit 10 is added.

The energy release unit 10 is further included, which is provided with a power resistor 101 and an NMOS transistor 102 and configured to release the electric energy of the energy storage unit 8 to implement shutdown control of the motor 12, avoiding constant energization of the system that can only be shut down after all the electric energy in the energy storage unit 8 has been released slowly.

A first specific embodiment of an electric pull device according to the present invention is as follows:
an electric pull device capable of pulling startup, which adopts the pulling startup module for an electric pull device described above and includes a tension rope, a motor 12, a driving unit 7, an energy storage unit 8, a switch control unit 9, and a processor 11, where the tension rope may be used to pull the motor 12, causing rotation of the motor 12 to generate a counter electromotive force; the driving unit 7 is provided with a bridge circuit and configured to rectify and convert the counter electromotive force into direct current electric energy; the energy storage unit 8 is provided with at least one capacitor and configured to store electric energy transmitted by the driving unit 7; the switch control unit 9 is provided with at least one transistor and configured to control energization of the motor 12 or/and the processor 11; the processor 11 is configured to control the rotation of the motor 12; when a user pulls the motor 12 through the tension rope, the motor 12 generates the counter electromotive force and transmits the same to the driving unit 7 through a circuit; the driving unit 7 converts the counter electromotive force into direct current electric energy and transmits the direct current electric energy to the energy storage unit 8 for storage; when stored electric energy is sufficient to turn on the transistor, the transistor is turned on, and then the motor 12 or/and the processor 11 is energized to start to work, thereby implementing startup control of the pull device.

A second specific embodiment of an electric pull device according to the present invention is as follows:
an electric pull device capable of pulling startup, which includes a tension rope, a motor 12, a driving unit 7, an energy storage unit 8, a switch control unit 9, a processor 11, a motor main switch, a power bus 1, a system bus 2, a motor bus 3, a main switch control line 4, and a motor switch control line 5. The tension rope may be used to pull the motor 12, causing rotation of the motor 12 to generate a counter electromotive force.

The driving unit 7 is provided with a bridge circuit and configured to rectify and convert the counter electromotive force into direct current electric energy. The energy storage unit 8 is provided with at least one capacitor and configured to store electric energy transmitted by the driving unit 7. The switch control unit 9 is provided with at least one transistor and configured to control energization of the motor 12 or/and the processor 11. The processor 11 is configured to control the rotation of the motor 12. The motor main switch is a button switch, a touch switch, or a toggle switch and configured to control on and off of the processor 11 and the motor 12. The power bus 1 is configured to be connected to a power supply or a battery and supply power to the motor 12. The system bus 2 is configured to be connected to the power bus 1 and the motor bus 3. The motor bus 3 is configured to be connected to the motor 12 and a control unit. The main switch control line 4 is configured to be connected to a system main switch and a control unit. The motor switch control line 5 is configured to be connected to a motor switch and a control unit. The transistor is a triode I 91 including a first collector c 911, a first base b 912, and a first emitter e 913. A branch circuit of the power bus 1 is electrically connected to the first collector c 911 via a PMOS transistor I 92, and another branch circuit is electrically connected to the first collector c 911 via a resistor I 95. The motor bus 3 and the main switch control line 4 are electrically connected to the first base b 912 separately, so that a main switch and the motor 12 separately control turning-on of the triode. The first emitter e 913 is grounded. The PMOS transistor I 92 is provided with a first source S 921, a first gate G 922 and a first drain D 923. The first source S 921 of the PMOS transistor I 92 is connected to the power bus 1, the first gate G 922 is connected to the first collector c 911, and the first drain D 923 is electrically connected to the motor bus 3 via the system bus 2. When a voltage at the first collector c 911 is zero, a voltage at the first gate G 922 is zero, and the PMOS transistor I 92 is turned on to implement energization control of the motor bus 3.

The system bus 2 is electrically connected to the motor bus 3 via a PMOS transistor II 94. The PMOS transistor II 94 is provided with a second source S 941, a second gate G 942, and a second drain D 943. The second source S 941 is electrically connected to the first drain D 923 via the system bus 2. The second gate G 942 is electrically connected to the motor switch control line 5 via a triode II 93. The second drain D 943 is electrically connected to the motor bus 3. The triode II 93 includes a second collector c 931, a second base b 932, and a second emitter e 933. A branch circuit of the second collector c 931 is electrically connected to the second gate G 942, and another branch circuit is connected to the system bus 2 via a resistor II 96. The second base b 933 is electrically connected to the motor switch control line 5. The second emitter e 933 is grounded. The motor switch control line 5 is energized to control turning-on of the triode II 93, causing a voltage of the second gate G 942 to be zero. The PMOS transistor II 94 is turned on, and then the motor bus 3 is energized to control startup of the motor 12.

According to the present invention, with full consideration on turning-on characteristics of the triode and the PMOS transistor, a plurality of triodes are used in conjunction with the PMOS transistor, so that on the one hand, the voltage of the main circuit may be kept stable, and on the other hand, less stored electric energy may be used for power supply to energize the control circuit and the main circuit, thereby implementing startup control of the pull device. The solution is simple, practical, and skillfully designed.

A third specific embodiment of an electric pull device according to the present invention is as follows:
an electric pull device capable of pulling startup, which adopts the pulling startup module for a pull device described above.

The module mainly includes a driving unit 7, an energy storage unit 8, a switch control unit 9, and an energy drain unit 10, where a specific composition is shown in FIG. 9.

In a shutdown state, by pulling a tension rope, a direct current brushless motor 12 is driven to rotate, and then the rotation generates an alternating current counter electromotive force, which is rectified and converted into direct current electric energy by a bridge circuit in the driving unit 7 and then output to a motor bus 3. An energy storage unit 8 is connected in parallel to the motor bus 3 for energy storage and filtering, and is mainly composed of capacitors. The electric energy generated by the rotation is stored in the energy storage unit 8 via the motor bus 3. When the electric energy (which can be implemented by adjusting a capacity of the capacitors) in the energy storage unit 8 reaches a voltage required to turn on a transistor in the switch control unit 9, a system main switch is turned on, a system bus 2 is energized, and then a processor 11 is energized and starts to work. The processor 11 first turns on a main switch control line 4 to keep the system main switch on, then detects a voltage of the energy storage unit 8 (i.e., the motor bus 3), determines pulling startup when the voltage reaches a preset threshold, and finally turns on a motor control line to turn on a motor control switch, so that the driving unit 7 is energized and starts to work normally, thereby completing a whole startup process.

During a shutdown using the module, the motor control switch needs to be turned off first, then an energy release control line 6 is turned on to completely release electric energy in the energy storage unit 8, and afterward, the main switch is turned off to complete a shutdown process; otherwise, the system may be constantly energized and can only be shut down after all the electric energy in the energy storage unit 8 has been released slowly.

According to the present invention, the structure is simple, the design is reasonable, and with full consideration of system energization and deenergization logics, an energy release unit 10 is introduced to enable quick deenergization of the system. At the same time, a mode of multi-circuit control with the main switch eliminates the need for the processor 11 to be always in a working state of detecting a bus voltage, thereby saving electric energy. The module has passed a practical test and is able to satisfy a requirement.

As shown in FIG. 6, a first specific embodiment of the switch control unit according to the present invention is as follows:
the switch control unit 9 includes a switch triode 97 and a switch MOS transistor 98; the switch triode 97 includes a switch collector c 971, a switch base b 972, and a switch emitter e 973; and the switch MOS transistor 98 includes a switch source S 981, a switch gate G 982, and a switch drain D 983. A branch circuit of the switch collector c is electrically connected to the switch gate G, and another branch circuit is electrically connected to a power bus 1 via a branch circuit resistor D 984; the switch base b is provided with an electric energy introduction interface 99 configured to receive electric energy; the switch emitter e is grounded; the switch source S is electrically connected to the power bus 1; and the switch drain D is connected to a motor bus 3 or a motor switch control circuit.

According to the present invention, with full consideration on turning-on characteristics of the triode and the MOS transistor, the triode is used in conjunction with the MOS transistor, so that on the one hand, the switch triode may be turned on using less electric energy, and on the other hand, a voltage the power bus may be kept stable, thereby implementing startup control of the pull device. The solution is simple, practical, and skillfully designed.

A second specific embodiment of the switch control unit 9 according to the present invention is as follows:
the PMOS transistor has three electrodes: a source(S), a gate (G), and a drain (D) respectively. A condition of turning on the PMOS transistor (i.e., turning on S and D electrodes) is that Vgs is less than Vgsth, where the latter voltage threshold is set by manufacturers of MOS transistors, different models correspond to different values, and a common value ranges from −1 V to −4 V, that is, when Vgs is less than this value, the MOS transistor is turned on. The triode also has three electrodes: b, e, and c electrodes respectively. An NPN triode is used in the present application, which is turned on (i.e., c and e electrodes are turned on) under a condition that Vbe is greater than 0.7 V (silicon triode).

When the power bus 1 is energized, as there is no control signal, Vbe is 0 V, which is less than 0.7 V, the triode is not turned on, equivalent to an open circuit. In this case, a potential of the G electrode of the MOS transistor is equal to a potential of the S electrode, Vgs is 0 V, which is greater than Vgsth. Therefore, the MOS transistor is not turned on, and the system is in a deenergized state. When there is a control signal (the motor bus 3 or the main switch control line 4 is at a high level), Vbe is greater than 0.7 V, the triode is turned on. At this time, the triode is equivalent to a wire that connects the G electrode to the ground. In this case, a potential of the G electrode is 0, Vgs is equal to 0-Vs. Since a battery voltage is generally much larger than Vgsth, Vgs (−Vs) is certainly less than Vgsth, the MOS transistor is turned on (as if a switch is turned on), and the system is energized.

A second embodiment of a startup method according to the present invention is as follows:
a pulling startup method for an electric pull device, including the following steps:
in a first step, when the pull device is in the shutdown or dormant state, the user pulls the tension rope to drive the direct current brushless motor 12 to rotate, and then the rotation of the direct current brushless motor 12 generates an alternating current counter electromotive force, which is rectified and converted into direct current electric energy by a bridge circuit in the driving unit 7; in a second step, the direct current electric energy obtained in the first step is transmitted to an energy storage unit 8 to implement electric energy storage;
in a third step, when the electric energy obtained in the second step reaches a voltage required to turn on a transistor, the transistor is turned on, a system main switch is turned on, a system bus 2 is energized, and then a processor 11 is energized and starts to work; in a fourth step, after the processor 11 in the third step starts to work, a main switch control line 4 is first turned on to keep the system main switch on, then a voltage of the energy storage unit 8 or a motor bus 3 is detected, and when the voltage reaches a preset threshold, pulling startup is determined; in a fifth step, when the pulling startup is determined in the fourth step, a motor control line is turned on to turn on a motor control switch, the driving unit 7 is energized and starts to work normally, thereby completing a whole startup process.

An apparatus embodiment which adopts the method according to the present invention is as follows:
a computer device, which includes:
one or more processors; and
a storage apparatus configured to store one or more programs,
the one or more programs, when executed by the one or more processors, causing the one or more processors to implement the pulling startup method for an electric pull device described above.

An embodiment of a computer medium which adopts the method according to the present invention is as follows:
a computer storage medium storing a computer program thereon, the program, when executed by a processor, causing the above pulling startup method for an electric pull device to be implemented.

Those skilled in the art should understand that the embodiments of the present application may be provided as methods, systems, or computer program products. Therefore, the present application may take the form of a full hardware embodiment, a full software embodiment, or an embodiment that combines software and hardware aspects. Further, the present application may take the form of a computer program product implemented on one or more computer-usable storage media (including, but not limited to, a disk memory, a CD-ROM, an optical memory, etc.) that contain computer-usable program code therein.

The present application is described with reference to flowcharts and/or block diagrams of methods, devices (systems), and computer program products according to the embodiments of the present application. It should be understood that each flow and/or block in the flowchart and/or block diagram and a combination of the flow and/or block in the flowchart and/or block diagram may be implemented by computer program instructions. These computer program instructions may be provided to a processor of a general-purpose computer, a specialized computer, an embedded processor, or other programmable data processing devices to produce a machine, such that the instructions executed by the processor of the computer or other programmable data processing devices produce an apparatus configured to implement a function specified in one or more flows of the flowchart and/or one or more blocks of the block diagram.

These computer program instructions may alternatively be stored in a computer-readable memory capable of guiding a computer or other programmable data processing devices to operate in a particular manner, such that the instructions stored in the computer-readable memory produce an article including an instruction apparatus that implements a function specified in one or more flows of the flowchart and/or one or more blocks of the block diagram.

Finally, it should be noted that the above embodiments are only used to illustrate the technical solutions of the present invention, rather than to limit them. Although the present invention has been described in detail with reference to the above embodiments, those skilled in the art should understand that the specific embodiments of the present invention may still be modified or replaced by equivalents, and any modifications or equivalent replacements that do not deviate from the spirit and scope of the present invention shall be covered by the scope of protection of the claims of the present invention.

The invention claimed is:

1. A pulling startup method for an electric pull device, wherein when the electric pull device is in a shutdown or dormant state, a user pulls a tension rope to drive a motor to rotate, thereby generating electric energy or an electric energy signal; and then startup control of the pull device is implemented by means of the electric energy or the electric energy signal.

2. The pulling startup method for an electric pull device according to claim 1, wherein a process of implementing the startup control of the pull device by means of an electric energy signal is as follows: when the pull device is in the shutdown or dormant state, the user pulls the tension rope to drive the motor to rotate, thereby generating the electric energy signal; and a processor completes a startup process when detecting the electric energy signal.

3. The pulling startup method for an electric pull device according to claim 2, wherein the processor detects the electric energy signal by means of a method as follows: during a shutdown, the processor is not deenergized and is in a state of monitoring a change in electric energy in real time; the state is implemented by detecting a voltage signal manifested by the electrical energy through real-time analog-to-digital conversion, or by detecting a rising edge trigger; and when the processor detects the electric energy signal, the processor works to control a power switch to be turned on, so as to implement the startup of the pull device.

4. The pulling startup method for an electric pull device according to claim 1, wherein a process of implementing the startup control of the pull device by means of electric energy is as follows: when the pull device is in the shutdown or dormant state, the user pulls the tension rope to drive the motor to rotate; and the rotating motor generates electric energy which energizes a processor or a switch control unit to implement the startup of the pull device.

5. The pulling startup method for an electric pull device according to claim 1, wherein a process of implementing the startup control of the pull device by means of electric energy is as follows: when the pull device is in the shutdown or dormant state, the user pulls the tension rope to drive the motor to rotate; and the rotating motor generates electric energy which, after being converted and accumulated, forms electric energy sufficient to turn on a transistor, and then the transistor is turned on to energize a processor or a switch control unit to implement the startup of the pull device.

6. A pulling startup module for an electric pull device, which adopts the pulling startup method for an electric pull device according to claim 1 and comprises a processor and a signal detection sensor, wherein the processor is configured to control startup of a motor;
the signal detection sensor is configured to detect an electric energy signal generated by pulling the motor; and
after the electric energy signal generated by pulling the motor is detected by the signal detection sensor, the signal detection sensor sends a startup signal to the processor, and then the processor controls startup of the pull device.

7. A pulling startup module for an electric pull device, which adopts the pulling startup method for an electric pull device according to claim 1 and comprises a processor and/or a switch control unit, wherein the processor and/or the switch control unit is provided with at least one transistor and configured to control startup of a motor; electric energy is generated by pulling the motor, and when electric energy is sufficient to turn on a transistor, the transistor is turned on to implement startup control of the pull device.

8. The pulling startup module for an electric pull device according to claim 7, wherein the switch control unit comprises a switch triode and a switch MOS transistor;
the switch triode comprises a switch collector c, a switch base b, and a switch emitter e; the switch MOS transistor comprises a switch source S, a switch gate G, and a switch drain D; a branch circuit of the switch collector c is electrically connected to the switch gate G, and another branch circuit is electrically connected to a power bus via a branch circuit resistor; the switch base b is provided with an electric energy introduction interface configured to receive electric energy;
the switch emitter e is grounded; the switch source S is electrically connected to the power bus; and the switch drain D is connected to a motor bus or a motor switch control circuit.

9. A pulling startup module for an electric pull device, which adopts the pulling startup method for an electric pull device according to claim 1 and comprises a driving unit, an energy storage unit, and a switch control unit, wherein the driving unit is provided with a bridge circuit and configured to rectify and convert alternating current electric energy generated by a user pulling a motor into direct current electric energy;
the energy storage unit is provided with a capacitor and configured to store electric energy output by the driving unit; the switch control unit is provided with at least one transistor and configured to control startup of the motor; the driving unit transmits, by means of a circuit, the direct current electrical energy to the energy storage unit for storage;
and when stored electric energy is sufficient to turn on a transistor, the transistor is turned on to implement startup control of the pull device.

10. The pulling startup module for an electric pull device according to claim 9, further comprising a power bus, a system bus, a motor bus, a main switch control line, a motor switch control line, and an energy release unit, wherein the bridge circuit comprises a plurality of field effect transistors forming a full-bridge rectification structure; there are a plurality of capacitors; the plurality of capacitors are connected in parallel to form an energy storage structure; the energy storage structure is capable of storing electric energy for turning on the transistor or/and storing electric energy for rotating the motor; the transistor is a triode I comprising a first collector c, a first base b, and a first emitter e; the power bus is configured to be connected to a power supply or a battery and supply power to the motor; the system bus is configured to be connected to the power bus and the motor bus;
the motor bus is configured to be connected to the motor and a control unit;
the main switch control line is configured to be connected to a system main switch and a control unit; the motor switch control line is configured to be connected to a motor switch and a control unit; the energy release unit is provided with a power resistor and an NMOS transistor and configured to release the electric energy of the energy storage unit to implement shutdown control of the motor; the power bus is electrically connected to the first collector c via a PMOS transistor I; the motor bus and the main switch control line are electrically connected to the first base b separately, so that a main switch and the motor separately control turning-on of the triode; the first emitter e is grounded; the PMOS transistor I is provided with a first source S, a first gate G and a first drain D; the first source S of the PMOS transistor I is connected to the power bus, the first gate G is connected to the first collector c, and the first drain D is electrically connected to the motor bus; when a voltage at the first collector c is zero, a voltage at the first gate G is zero, and the PMOS transistor I is turned on to implement energization control of the motor bus; the first drain D is electrically connected to the motor bus via a PMOS transistor II; the PMOS transistor II is provided with a second source S, a second gate G, and a second drain D;
the second source S is electrically connected to the first drain D; the second gate G is electrically connected to the motor switch control line via a triode II; the second drain D is electrically connected to the motor bus; the triode II comprises a second collector c, a second base b, and a second emitter e;
the second collector c is electrically connected to the second gate G; the second base b is electrically connected to the motor switch control line; the second emitter e is grounded; the motor switch control line is energized to control turning-on of the triode II, causing a voltage of the second gate G to be zero; the PMOS transistor II is turned on, and then the motor bus is energized to control startup of the motor.

11. An electric pull device capable of pulling startup, which adopts the pulling startup method for an electric pull device according to claim 1, and comprises a tension rope, a motor, a driving unit, an energy storage unit, a switch control unit, and a processor, wherein the tension rope may be used to pull the motor, causing rotation of the motor to generate a counter electromotive force; the driving unit is provided with a bridge circuit and configured to rectify and convert alternating current electric energy into direct current electric energy; the energy storage unit is provided with at least one capacitor and configured to store electric energy transmitted by the driving unit; the switch control unit is provided with at least one transistor and configured to control energization of the motor or/and the processor;
the processor is configured to control the rotation of the motor; when a user pulls the motor through the tension rope, the motor generates the counter electromotive force and transmits the same to the driving unit through a circuit; the driving unit converts the counter electromotive force into direct current electric energy and transmits the direct current electric energy to the energy storage unit for storage; when stored electric energy is sufficient to turn on the transistor, the transistor is turned on, and then the motor or/and the processor is energized to start to work, thereby implementing startup control of the pull device.

12. A pulling startup method for an electric pull device, wherein when the electric pull device is in a shutdown or dormant state, a user pulls a tension rope to drive a motor to rotate;
the rotating motor generates an electromotive force which, after being converted and accumulated, forms electric energy sufficient to turn on the transistor, and then the transistor is turned on to energize a motor switch circuit, thereby implementing startup control of the pull device, which comprises the following steps:
in a first step, when the pull device is in the shutdown or dormant state, the user pulls the tension rope to drive the direct current brushless motor to rotate, and then the rotation of the direct current brushless motor generates an alternating current counter electromotive force, which is rectified and converted into direct current electric energy by a bridge circuit in the driving unit; in a second step, the direct current electric energy obtained in the first step is transmitted to an energy storage unit to implement electric energy storage;
in a third step, when the electric energy obtained in the second step reaches a voltage required to turn on a transistor, the transistor is turned on, a system main switch is turned on, a system bus is energized, and then a processor is energized and starts to work; in a fourth step, after the processor in the third step starts to work, a main switch control line is first turned on to keep the system main switch on, then a voltage of the energy storage unit or a motor bus is detected, and when the voltage reaches a preset threshold, pulling startup is determined; in a fifth step, when the pulling startup is determined in the fourth step, a motor control line is turned on to turn on a motor control switch, the driving unit is energized and starts to work normally, thereby completing a whole startup process; when the pull device needs to be shut down, the motor control switch is turned off first, then an energy release control line is turned on to completely release electric energy in the energy storage unit, and afterward, the main switch is turned off to complete a shutdown process.
